(19) United States
(12) Patent Application Publication
(10) Pub. No.: US 2019/0168383 A1
(43) Pub. Date: Jun. 6, 2019

(54) METHOD AND DEVICE FOR DEFINING A MOVEMENT SEQUENCE FOR A ROBOT

(71) Applicant: KASTANIENBAUM GMBH, Munich (DE)

(72) Inventor: Sami Haddadin, Hannover (DE)

(73) Assignee: KASTANIENBAUM GMBH, Munich (DE)

(21) Appl. No.: 16/095,622

(22) PCT Filed: Apr. 21, 2017
(86) PCT No.: PCT/EP2017/059570

§ 371 Date: Feb. 7, 2019

(30) Foreign Application Priority Data
Apr. 24, 2016 (DE) 10 2016 004 841.7

(51) Int. Cl. B25J 9/16; G05B 19/423

(52) U.S. Cl. CPC B25J 9/163; G05B 19/423; G05B 2219/39001; G05B 2219/35478; B25J 9/1664

(57) ABSTRACT

The present invention relates to a method and to a device for defining a movement sequence for a multi-axis manipulator of a robot system, which manipulator has a plurality of elements which form different rotational axes, and an end element for interaction with an effector, wherein the effector is intended to carry out at least one arbitrary operation in a working space, and wherein in order to carry out the at least one arbitrary operation the end element of the manipulator is to be transferred into an arbitrary target pose with respect to the working space, wherein the manipulator moves in a plurality of steps to the target pose while approaching the end element, and for each step at least one defined impedance pattern and/or admittance pattern is defined with respect to at least one axis which forms the axis of a coordinate system which is linked to the manipulator.

This invention relates to a method and a device for defining or determining a motion sequence for a robot, wherein the motion sequence is required to perform any operation in a workspace assigned to the robot.

The method according to the invention serves to accordingly program a robot system, in particular, but not exclusively, of the lightweight construction.

Such lightweight robot systems are designed in such a way that, in addition to the necessary six degrees of freedom, they also have one or more degrees of freedom that allow the so-called null space to be spanned.

In order for the robot system to be able to perform the desired operations during subsequent activity and to adopt the corresponding poses for this purpose, it must be freely programmable with regard to motion sequence and force application or transmission at an end effector. In the abstract sense, the robot system initially represents a state-based machine that is freely programmable with respect to or in several axes.

A common online, i.e. almost real-time programming method for robot systems of this type is the so-called “teach-in” method, in which the individual support points of the desired trajectories are approached and then the respective position of the effector is detected via encoders integrated in the robot system and stored in a control unit.

The so-called direct “teach-in” process is used, particularly in lightweight robot systems, in which the effector or manipulator or robotic arm is guided and moved directly and manually by an operator, i.e. the required motion sequence is demonstrated to the manipulator in advance.

This is only possible if, on the one hand, the robotic arm only has such a weight and/or a corresponding sensitivity that it can still be moved by an operator, and, on the other hand, if there are no strongly transmitting and thus self-locking gear mechanisms between the individual links or arm members of the robotic arm, or if a corresponding torque control is provided for the use of gears with high transmission ratios.

For the direct “teach-in” method mentioned above, it is therefore also known that the robot system is guided in its so-called gravitation-compensated state, in which the measured torques are fed back to the thereby active drives between the individual links, which means that the dead weight of the robot system and any self-locking of the gear mechanisms are not taken into account, and therefore the robot system can only be moved as a function of the external forces applied by an operator during manual guidance. Further approaches include a direct targeted control of the torques in relation to the individual motors, taking into account specified schemes or programs for friction compensation.

The movements performed in the “teach-in” process are measured by sensors already existing in the area of the drive mechanisms and joints between the individual links of a robotic arm, which can detect both torques and translational forces. A corresponding selection of the scanning/sampling times then results in a large number of path points that subsequently determine the trajectories to be followed or traversed by the robotic arm. These are therefore not described analytically, but are determined exclusively by the manual guidance of the operator and thus by the course in space. The existing sensors can detect forces and torques along the entire structure of the robot system.

A robot system with a high degree of flexibility due to the provision of a large number of degrees of freedom can therefore hardly be realized, or only with considerable programming effort, as a system that can be designed to be completely traceable across all degrees of freedom, which in turn leads to the fact that the manual guidance of a manipulator of such a robot system has several disadvantages.

A manipulator of a lightweight robot usually provides seven degrees of freedom with regard to its mobility. The definition of a working or task space in which the robot is to perform one or more operations is, however, limited to six dimensions, e.g. when using a Cartesian space, whereby an additional degree of freedom exists for the manipulator, which is usually referred to as null space. However, this leads to the fact that a movement of the manipulator during a “teach-in” programming by the user is hardly manageable, since the manipulator can also move in coordinates, and this purely coincidentally, which are not relevant for the intended task(s). Apart from the fact that such behavior of the robot is basically not desired and can hardly be interpreted correctly by operators who are not so familiar with programming such robot systems, such behavior proves to be very inefficient when programming the robot system.

Since the manipulator itself cannot actively contribute to moving within the correct coordinates of the assigned workspace due to its very passive behavior with respect to the movements in its joints, it becomes apparent that high-precision positioning of the manipulator and thus of the effector in the workspace is very difficult to carry out.

The robot systems usually have an input device in the area of the robotic arm with which, for example, the gravitational-compensating mode of the robot system can be activated or deactivated for carrying out the “teach-in” procedure.

As a result, the operator needs one hand to operate the input device activating the gravitational compensating mode and the other hand to guide the effector manually. This means that it is no longer possible to specifically influence those degrees of freedom that do not come into play when guiding the effector into the desired position, which would be advantageous for a highly accurate “teach-in” process. In other words, a user always needs both hands to achieve exact positioning.

Another disadvantage of robot systems that are to perform defined operations in a workspace is that for each individual operation an independent programming or “teach-in” procedure must be carried out, although the operations may be identical in nature, but must be carried out at different positions within the workspace. So it is conceivable that the similar operation consists of connecting two elements, such as housing parts, to each other, e.g. to be screwed together. The screwing operation as such would be the same due to the identical screws used and the dimensions of the threaded holes on the housing parts, with the positions of the threaded holes being distributed along the housing parts. If state-of-the-art programming or “teach-in” procedures were used, these would have to be repeated for each individual threaded hole for the screwing process. This requires a certain amount of time and therefore cost-intensive programming.

Based on this it is an object of the present invention to provide a robot system and a method for programming such a robot system, which eliminate the above-mentioned disadvantages. Furthermore, it is an object of the invention to provide in this context a method and a device for the definition of a defined motion sequence for a robot system, which allows a simple replicability and transferability of the operations to be carried out by these motion sequences.

This object is solved with a method according to claim 1, a robot system according to claim 20 and a device according to claim 21.

The invention thus relates to a method for determining a motion sequence for a multi-axis manipulator of a robot system comprising a plurality of members forming different rotational axes and an end member for cooperating with an effector, wherein the effector is to perform at least one arbitrary operation in a workspace or task space, and wherein the end member of the manipulator is to be transferred to an arbitrary target pose with respect to the workspace to perform the at least one arbitrary operation, the method being characterized by
moving the manipulator in several steps with the end member approaching the target pose,
   wherein for each step at least one defined impedance pattern and/or admittance pattern with respect to at least one axis forming the axis of a coordinate system associated with the manipulator is determined.

The manipulators of lightweight robots consisting of several axis members are usually modelled and controlled as rigid bodies, elastic and/or viscoelastic elements, e.g. as a spring-mass system. Such a spring-mass system has a spring stiffness and/or impedance, whereby the spring stiffness can be changed via control loops and thus an impedance behaviour can be determined in relation to the task space. This spring stiffness can be specifically influenced and adequately dampened by controlling the individual drive units arranged in the joints between two axis links, which in principle allows defined compliance patterns to be achieved. In other words, the motion and interaction behaviour of the manipulator as a whole can be specifically influenced.

This possibility is now used according to the invention of applying defined impedance patterns and/or admittance patterns to individual axes of one and the same coordinate system or of different coordinate systems when programming a desired motion sequence for a manipulator or during “teach-in”. In the simplest form, these are defined compliance patterns.

According to the invention, this may be an arbitrary coordinate system directly associated with at least one of the axis members of the manipulator, another of the axis members of the manipulator, one or more joints between two axis members movably connected to each other via these, the effector located on the end member of the manipulator and/or the workspace in which the effector performs one or more operations. There may also be different arbitrary coordinate systems. In addition, it could also be a coordinate system which axes can be automatically identified, for example with reference to a manifold, i.e. the system for carrying out the method learns automatically which coordinate system could be the most suitable in each case.

In addition, the invention may provide that the arbitrary coordinate system is determined by the type of effector, the pose to be adopted and/or the type of operation to be performed. If, for example, a screwing operation is to be performed by the effector, a screwdriver, the arbitrary coordinate system can then be defined as a polar coordinate system in this context. It is also possible that the arbitrary coordinate system is designed to be time-variant if, for example, the manipulator has to follow a predetermined motion to perform the intended operation, which is determined, for example, by a conveyor belt moving along the robot in the area of the workspace.

Within these arbitrary coordinate systems, the invention then provides that the axis(axes) selected for the application of the impedance patterns and/or admittance patterns shall refer to a translational orientation or to a rotational orientation. In other words, programming may therefore apply a targeted impedance behaviour and/or admittance behaviour with respect to a partial or total translational movement of the manipulator and/or an impedance behaviour and/or admittance behaviour with respect to a partial or total rotational movement of the manipulator.

In a preferred embodiment of the method according to the invention it is provided that then
for a step, a defined impedance pattern and/or admittance pattern is defined with respect to an axis in a translational orientation or alignment, and
for a further step, a defined impedance pattern and/or admittance pattern is defined with respect to an axis in a rotational orientation or alignment.

These steps can then be repeated (in an even or odd number) until the desired target pose is reached. Within these repetitions, the same impedance patterns and/or admittance patterns already defined for the previous steps can then be used for each individual step, or the impedance patterns and/or admittance patterns can be varied between the steps.

The method according to the invention is therefore characterized by the fact that the desired motion sequence can be programmed in several steps or loops by approaching the final pose in several steps.

The number of steps can be chosen arbitrarily or depends on the spatial circumstances. Thus it is possible that to achieve one and the same pose in a workspace, different motion sequences can result from different programming procedures through manual guidance. If the space in which the manipulator moves during “teach-in” according to the inventive method is free of obstacles, the manipulator could be guided more or less directly to the target in just a few steps. If obstacles have to be taken into account, e.g. the position of a human at workplaces designed for a human-robot collaboration, the manipulator can be guided around these obstacles to the desired target in several steps.

According to the invention, the impedance patterns and/or admittance patterns are designed to be constant, time-varying and/or state-dependent during a step.

For carrying out the method according to the invention, a robot system with a manipulator providing the multiple degrees of freedom can have a control unit and an input device for programming the robot system, wherein the control unit and the input device are designed in such a way that during the programming of the robot system at least one impedance pattern and/or admittance pattern is applied to an axis of a coordinate system. This means that at least one degree of freedom of the multiple degrees of freedom is controllable with respect to an inherent mobility of that degree of freedom.

The control unit is designed in such a way that it determines the or more coordinate systems in advance according to the parameters mentioned above and then selects the type of coordinate system which seems most appropriate for the required purpose. In addition to preferably Cartesian coordinate systems, cylindrical coordinate systems, spherical coordinate systems or coordinate systems defined by manifolds are also conceivable.

The inventive robot system or method enables the operator to apply defined impedance patterns and/or admittance patterns to individual joints of the robot system for programming purposes as required, e.g. to dampen by means of defined compliance patterns, and thus selectively influence the degrees of freedom of the robot system in order to set the degree of mobility of the degree of freedom for a movement to be performed during programming of the robot system. In this way, the movements can be defined, taking into account the previously defined coordinate systems, either in terms of rotational and/or translational orientation, as previously mentioned.

The invention is accompanied by the advantage that, instead of repeatedly activating or deactivating the gravitation-compensated mode during “teach-in”, a multi-stage, selectively programmable control method is proposed, in which only part of the multiple degrees of freedom present in the robot system can be changed by external forces at any time, i.e. dampened and/or blocked selectively by applying defined impedance patterns and/or admittance patterns, such as e.g. compliance patterns. As a result, this also means that an operator can reduce the number of available multiple degrees of freedom of the robot system for a movement to be performed during programming of the robot system, which movement results from manual guidance. This is done by selectively and individually dampening or blocking one or more degrees of freedom so that a movement is limited to the unblocked degrees of freedom, especially with regard to interaction with the environment. Blocking in this context is not to be understood in the sense of an absolute block; preferably one joint is subjected to extremely hard damping, which means that such high stiffness ultimately leads to a blockage of the joint, whereby minimal light movements are still possible, while another joint is subjected to extremely soft damping, which means that such low stiffness leads to a loosening of this joint.

For example, the relative motions made possible by the joint mechanisms, e.g. between individual links of a robotic arm, are to be damped in a targeted manner, with the degree of damping being adjusted differently and varying from joint to joint. This can be achieved by controlling the drive mechanisms arranged in the joint points accordingly.

In a simple case, for example, a three-step procedure could be applied in which the manipulator is first converted to a gravitation-compensated (and/or centrifugal and/or coriolis force and/or inertia-compensated) state in order to bring the manipulator roughly into the vicinity of the desired pose.

Then only the rotation axes are released with respect to a coordinate system associated to the end effector to make a first correction of the end effector orientation. Then these rotation axes are nearly blocked, i.e. provided with an extremely high stiffness, and only the translational axes are released in relation to this coordinate system, so that the final position of the end effector is set. These steps can be repeated in one or more loops until the final desired pose is reached in the sense of a fine adjustment.

This makes programming as such much easier, as the operator can manage a multi-joint robot system with an effector much more easily, also with regard to the degrees of freedom not relevant to the task, and can also set poses of the robot system, with the help of which trajectories can be defined that take into account previously known obstacles, such as a work area of a worker in the immediate vicinity of the robot system in later operation.

The input device can be located on a member of the robot system, preferably in the area of the end effector, or it can be an external tablet, allowing the operator to manually activate or deactivate the desired compliance patterns, in real time, with one hand, and to distinguish between individual joints of the manipulator.

The programming method according to the invention also facilitates one-handed guidance of, for example, 7-axis manipulators having a null space, which further reduces set-up times while reducing set-up costs.

In a particularly preferred embodiment, the method according to the invention is furthermore characterized in that a total impedance pattern and/or total admittance pattern, generated after carrying out all the individual steps, for the motion to be defined with respect to the target pose is applied to at least one further target pose while maintaining a common target orientation within the framework of the impedance behaviour and/or admittance behaviour, wherein the position or translation of the further target pose is offset relative to the position or translation of the original target pose within a common plane and/or angularly relative thereto.

This makes it possible to repeatedly use a target orientation of the robotic arm and thus of the effector once it has been determined by the “Teach-in”, for example to determine parallel objects located on one level. Once the target orientation of a pose has been set, it is maintained and only its respective position is changed. For example, when screwing together a housing cover with several positions of the screw guides distributed over the cover, only the target position or translation of the end effector is taught with a screwdriver element in relation to the position of the respective threaded hole, while the target orientation resulting from the screw motion to be performed is retained. The programming times can thus be further shortened.

The method according to the invention offers a new concept for programming or determining a motion sequence for a multi-axis manipulator of a robot system, in particular of the lightweight design, which is characterized by the selection of different compliance patterns or impedance profiles to restrict the movements in relation to a workspace. An overall compliance behaviour of the manipulator is determined with respect to the workspace in order to be adjusted to a specific task or operation. If different coordinate systems on the one hand and different compliance behaviours on the other hand do become necessary for a desired interaction, it is possible to switch back and forth between the individual impedance profiles and/or admittance profiles in a simple way during the

“Teach-in” process, in particular by direct input at the robot.

Further advantages and features of the invention do become apparent from the description of the embodiments as shown in the enclosed drawings.

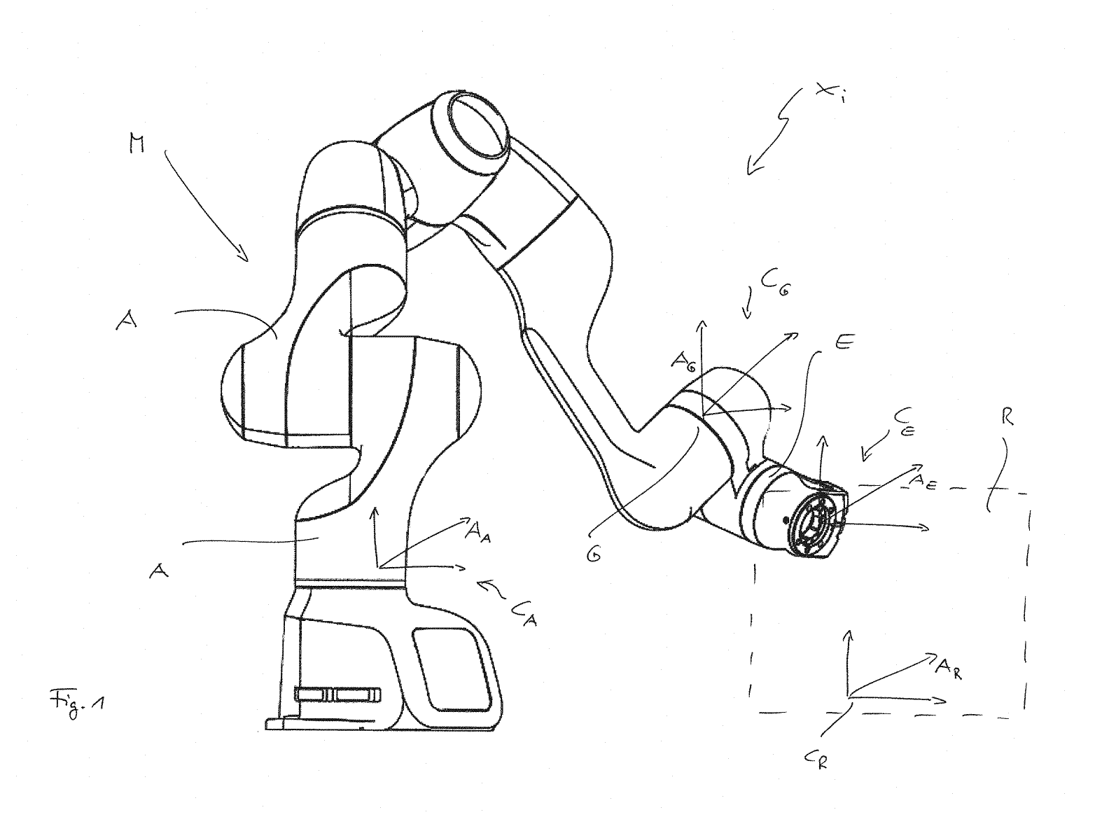

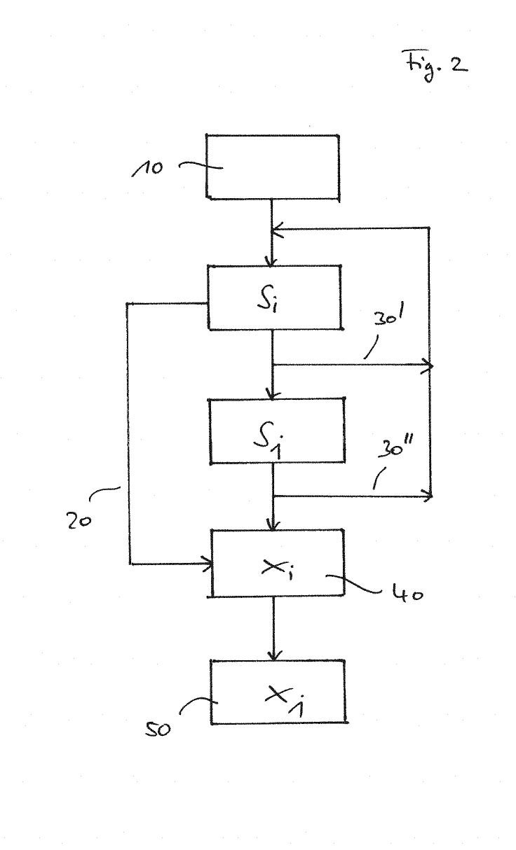

FIG. 1 is an exemplary illustration of a multi-axis manipulator of a robot system, in which possible coordinate systems for the method according to the invention are schematically indicated;

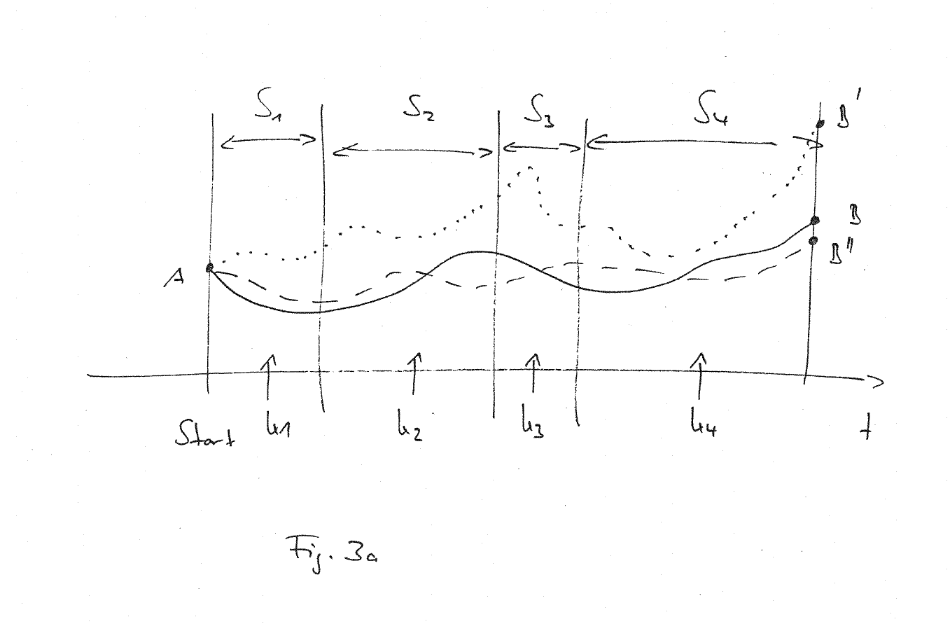

FIG. 2 is a flowchart illustrating the essential steps of an embodiment of the method according to the invention;

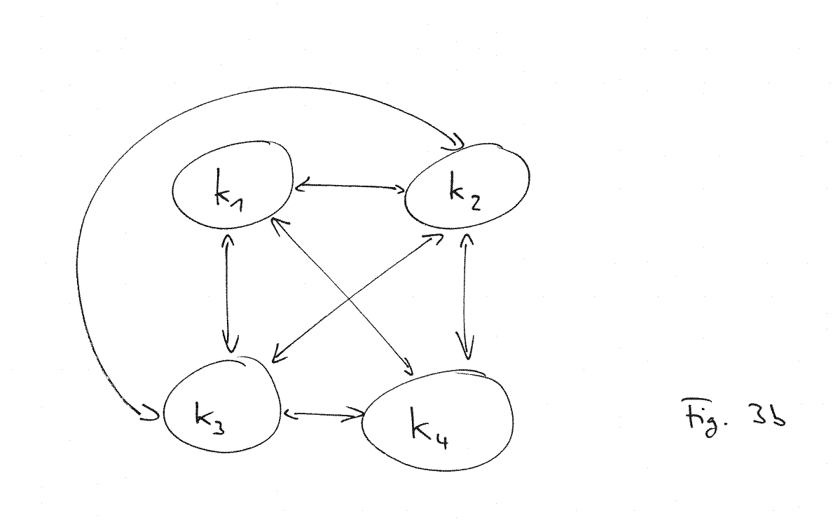

FIG. 3a is a diagram illustrating a step-by-step method according to the invention as compared to known methods; and

FIG. 3b is a scheme of the possible mutual interrelationships of individual compliance patterns, whereby only stiffnesses are provided.

FIG. 1 shows an example of a robot system with a manipulator M consisting of several axis links or members A, which are connected to each other via joints G. At the end of the manipulator M, an effector E is provided, which is to carry out a certain operation in a workspace or task space R.

Several coordinate systems can be assigned to the manipulator M, which is to take a pose xᵢ, which are schematically shown in FIG. 1, in this case as Cartesian coordinate systems. However, other coordinate systems are also conceivable, e.g. coordinate systems associated with manifolds.

A first coordinate system C_{A} can, for example, refer to one of the axis elements A and have corresponding axes A_{A} within this coordinate system C_{A}, which define this coordinate system C_{A}.

A second coordinate system C_{E} is directly related to the effector E and has axes A_{E} defining this coordinate system C_{E} accordingly.

A third coordinate system C_{G} can refer directly to a single joint G and is defined accordingly by the axes A_{G}.

The fourth coordinate system C_{R} can be a coordinate system that refers to the workspace R and is defined via the corresponding axes A_{R}.

In the “Teach-in” method according to the invention, the manipulator M is transferred into a pose xi in several steps Sᵢ, Sⱼ (see FIGS. 2 and 3a) by approximating the effector E or the end member of the manipulator M carrying it to the final pose xᵢ, whereby the pose xᵢ results from the workspace R itself, which corresponds to the location of an operation to be performed in this, e.g. an assembly workstation, and from the type of operation to be performed, e.g. screw motion. However, it can also be a matter of simply positioning the effector E in space, which is not directly derived from a task.

For each step Sᵢ, Sⱼ, at least one defined impedance pattern and/or admittance pattern is defined, in the present case a compliance pattern, resulting from an impedance or stiffness matrix Kₓ.

According to the invention, the impedance patterns and/or admittance patterns should be designed in such a way that they relate to at least one axis of a selected coordinate system, e.g. to at least one axis A_{A} of the coordinate system C_{A} of one or more axis members A, to at least one axis A_{G} of the coordinate system C_{G} of one or more joints G, to at least one axis A_{E} of the coordinate system C_{E} of the effector and/or to at least one axis A_{R} of the coordinate system of one or more work or task spaces R.

FIG. 2 shows schematically a flow chart of an example of the execution of the method according to the invention, which can be carried out manually by an operator on a robot system for the programming thereof.

In a first step 10, the manipulator M is set to a compensated mode. For this purpose, corresponding counterforces and counter-torques are generated by corresponding control of the drive units in the joints G in order to counteract the force of gravity, possibly a centrifugal force and/or a Coriolis force and/or initiated inertial forces, whereby the dead weight and thus the inertia of the manipulator M and any self-locking of the gears or joints is cancelled, so that the manipulator M can in the first place exhibit a repellable behaviour.

The operator is now able to bring the robotic arm or effector E approximately into the desired pose and/or move it to the desired position.

If, for example, a Cartesian coordinate system is taken into account as the relevant coordinate system, possible Cartesian task-related stiffness elements, which define the translational and rotational Cartesian stiffness in the decoupled case, result as

k_{x,i} ∈ [symbol] ⁺, i ∈{1 . . . 6}

If the manipulator M can be moved freely in certain directions, the nₜ-th stiffness elements assigned to it are defined as

k_{x,i}=0

For this purpose, a specific Cartesian task-related damping d_{x,i} can be selected for the directions restricted to 6−nₜ by specifying or selecting a damping profile or compliance pattern.

It should be mentioned that in practice an attenuation or impedance with respect to the null space should not be specified in detail in order to exclude an interaction with the task or operation under real conditions (e.g. due to sensor noise). Nevertheless, it can also be provided that an independent, e.g. possibly time-variant compliance pattern is assigned to the null space within the framework of the method according to the invention.

In simple terms, this results in a Cartesian stiffness matrix as

$${K}_{x} = ( \begin{matrix}{K}_{x , t} & 0 \\ 0 & {K}_{x , r}\end{matrix} )$$

in which

K_{x,t}, K_{x,r}∈ [symbol] ^{3×3}

reflect the translational and rotational diagonal, positively defined stiffness matrices.

In a first step Sᵢ of the above-mentioned approximation, a compliance pattern is then defined with respect to one axis of a Cartesian coordinate system, e.g. the axis A_{A} of the coordinate system C_{A}, in a translational alignment. The corresponding stiffness matrix results then as

$${K}_{x}^{t - teach} = ( \begin{matrix}{k}_{x , tx} & 0 & 0 & 0 & 0 & 0 \\ 0 & {k}_{x , ty} & 0 & 0 & 0 & 0 \\ 0 & 0 & {k}_{x , tz} & 0 & 0 & 0 \\ 0 & 0 & 0 & 0 & 0 & 0 \\ 0 & 0 & 0 & 0 & 0 & 0 \\ 0 & 0 & 0 & 0 & 0 & 0\end{matrix} )$$

A single execution of this step Sᵢ could already be sufficient to reach the target pose xᵢ (step 20 in FIG. 2). However, step Sᵢ could also be repeated one or more times (step 30′ in FIG. 2).

In a further step Sⱼ of the approximation, a defined compliance pattern in a rotational orientation is then defined for this axis A_{A} of the coordinate system. The corresponding stiffness matrix results as follows

$${K}_{x}^{r - teach} = ( \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & {k}_{x , rx} & 0 & 0 \\ 0 & 0 & 0 & 0 & {k}_{x , ry} & 0 \\ 0 & 0 & 0 & 0 & 0 & {k}_{x , rz}\end{matrix} )$$

These steps of the “teach-in” procedure according to the invention can be repeated as often as necessary, but not necessarily alternately (steps 30′, 30″ in FIG. 2), until finally pose xᵢ has been reached (step 40 in FIG. 2).

The steps, in which the focus is only once to the translational alignment and only once to the rotational alignment, are therefore essentially simplified “teach-in” steps in themselves.

The method according to the invention can preferably be used to transfer a once determined and set pose xᵢ to another target pose xⱼ, which differs from pose xᵢ only by a different position, but has a common target orientation or alignment (step 50 in FIG. 2).

For example, in pose xᵢ there is a screw which is to be screwed into a component by the effector E of the manipulator M. At further positions of the component there are s-1 screws, which are also to be screwed in.

After the transition to the e.g. gravitation-compensated mode, a change is made between the translational and rotational states, as mentioned above. The stiffness matrix is user-defined by the selection of the compliance patterns, i.e.

Kₓ=User(Kₓ^{t-teach}, Kₓ^{r-teach})

If the pose xᵢ is reached, it is stored as a reference.

After that, the system switches to a mode in which the manipulator M is guided to the further s-1 positions of the further screws, and there only the position is saved, since the orientation is the same. The corresponding matrix results then as

$${K}_{x}^{t - top} = ( \begin{matrix}0 & 0 & 0 & 0 & 0 & 0 \\ 0 & 0 & 0 & 0 & 0 & 0 \\ 0 & 0 & 0 & 0 & 0 & 0 \\ 0 & 0 & 0 & {k}_{x , rx} & 0 & 0 \\ 0 & 0 & 0 & 0 & {k}_{x , ry} & 0 \\ 0 & 0 & 0 & 0 & 0 & 0\end{matrix} )$$

For each further pose xⱼ therefore then

Kₓ=Kₓ^{t-top}

It becomes clear that by using the previous compliance patterns, which are defined by the stiffness matrices, any number of further poses xᵢ, xⱼ . . . xₛ can be programmed in a systematic way.

FIG. 3a illustrates in an exemplary manner the advantage of the method according to the invention in comparison to known “teach-in” methods. This FIG. 3a shows the course of the individual steps in which the effector E of a manipulator M is to assume a pose at a specific target point B in a workspace R.

It should be emphasized that the target point B, at which an operation by the effector E of the manipulator M is ultimately to be performed, is not known as an input variable or parameter for programming the motion sequence that the manipulator M is to follow through for this purpose.

A movement of a manipulator M is to be started from an initial state at position A, which can be anywhere in the space, which is completely separated and decoupled from the workspace R, in which position B is located.

With a pure motion programming (dotted line) the manipulator M with its effector E would end at any point B′, which inevitably cannot match with the desired position, because it is either not known or only insufficiently known. Since B is not known beforehand or only insufficiently known, but only implicitly by the result to be achieved (pose, operation at point B), no environmental model can be generated that could be used for pure motion programming.

In “Teach-in” programming, in which the manipulator M is only guided in a gravitation-compensated state (dashed line), the effector E always ends in a position B″ that is too inaccurate and therefore deviates from the desired position B, even if only minimally. However, a minimal deviation is already sufficient to ensure that the desired operations, such as screwing in a screw, cannot be carried out error-free and in a reliably replicable manner. In addition, the “teach-in” procedure, i.e. ultimately the guiding of the manipulator, proves to be much more difficult to perform in the present case.

According to the invention, the guidance of the manipulator M is therefore divided into several steps S1 to S4, which can have different durations, and each step is then assigned a stiffness matrix K1 to K4 each defining a compliance pattern. In this way, the effector E can approach position B exactly (solid line) in order to assume the pose x_{B} necessary for the intended operation.

When the different stiffness matrices K1 to K4 are used, possibly with simultaneous compensations with respect to gravity, inertia, centrifugal forces and/or Coriolis forces, these can in turn be coordinated with one another via steps S1 to S4, i.e. the resulting individual compliance patterns are all interrelated with one another, as FIG. 3b illustrates.

It becomes clear that through the targeted selection of the number of steps on the one hand and through the targeted selection of the impedance patterns and/or admittance patterns, in the simplest case of compliance patterns, on the other hand a step-by-step realization of the desired pose(s) becomes possible, which is not included into the programming of the motion sequence in advance due to lack of knowledge.

1. Method for determining a motion sequence for a multi-axis manipulator of a robot system which has a plurality of links forming a plurality of different rotational axes and an end link for interaction with an effector, the effector being intended to carry out at least one arbitrary operation in a workspace, and the end link of the manipulator being intended to be transferred into any arbitrary target pose with respect to the workspace in order to carry out the at least one arbitrary operation,
comprising:
moving the manipulator in several steps (Si; Sj) with the end link approaching the target pose,
wherein for each step (Si; Sj) at least one defined impedance pattern and/or admittance pattern is determined with respect to at least one axis forming the axis of a coordinate system associated with the manipulator.

2. Method according to claim 1, in which the at least one axis refers to a translational orientation and/or to a rotational orientation.

3. Method according to claim 2, in which
for a step (Si), a defined impedance pattern and/or admittance pattern is determined with respect to an axis in a translational orientation, and
for a further step (Sj), a defined impedance pattern and/or admittance pattern is determined with respect to an axis in a rotational orientation.

4. Method according to claim 3, in which at least one of the steps (Si; Sj) or all of the steps (Si; Sj) is/are repeated n times until the target pose is reached.

5. Method according to claim 4 in which, for each step (Si; Sj) of the n-th repetition, the respectively defined impedance pattern and/or admittance pattern is maintained or varied.

6. Method according to claim 3, in which the impedance patterns and/or admittance patterns are designed to be constant, time-varying and/or sate-dependent during a step (Si; Sj).

7. Method according to claim 1, further comprising the step:
determining at least one arbitrary coordinate system with respect to said manipulator.

8. Method according to claim 7, in which an arbitrary coordinate system is determined with respect to an axis member of the manipulator.

9. Method according to claim 7 in which an arbitrary coordinate system is determined with respect to a joint between two axis members of the manipulator.

10. Method according to claim 7, in which an arbitrary coordinate system is determined with respect to the effector.

11. Method according to claim 7, in which an arbitrary coordinate system is determined with respect to the workspace.

12. Method according to claim 8, in which the arbitrary coordinate system is determined as a function of the target pose.

13. Method according to claim 8, in which the arbitrary coordinate system is designed to be time-variant.

14. Method according to claim 8, in which the arbitrary coordinate system is determined as a function of the operation to be performed.

15. Method according to claim 1, further comprising the step:
converting the manipulator into a gravitation-compensated state and/or centrifugal force-compensated state and/or coriolis force-compensated state and/or inertia-compensated state.

16. Method according to claim 1, in which a total impedance pattern and/or total admittance pattern for the motion sequence to be determined with respect to the target pose, which pattern(s) is/are generated after carrying out the steps (Si; Sj), is/are applied to at least one further target pose while maintaining a common orientation within the framework of the impedance behavior and/or admittance behavior, the position of the further target pose being offset relative to the position of the target pose within a common plane and/or at angularly relative thereto.

17. Computer program comprising program instructions which cause a processor to execute and/or control the steps of the method according to claim 1 when the computer program is running on the processor.

18. Data carrier device on which a computer program is stored in accordance with claim 17.

19. Computer system comprising a data processing apparatus, the data processing apparatus being arranged such that a method according to claim 1 is performed on the data processing apparatus.

20. Robot system comprising a multi-axis manipulator and an end member of the manipulator for performing an operation, comprising means for performing the method according to claim 1.

21. Device for determining a motion sequence for a multi-axis manipulator of a robot system which has a plurality of links forming a plurality of different rotational axes and an end link for interaction with an effector, the effector being intended to carry out at least one arbitrary operation in a workspace, and the end link of the manipulator being intended to be transferred into any arbitrary target pose with respect to the workspace in order to carry out the at least one arbitrary operation, wherein the device is designed such that the following steps can be carried out:
moving the manipulator in several steps (Si; Sj) with the end link approaching the target pose,
wherein for each step (Si; Sj) at least one defined impedance pattern and/or admittance pattern is determined with respect to at least one axis forming the axis of a coordinate system associated with the manipulator.

22. Robot equipped with a manipulator and a device as described in claim 21.
